(19) United States
(12) Patent Application Publication
(10) Pub. No.: US 2022/0075773 A1
(43) Pub. Date: Mar. 10, 2022

(54) COMPUTER-READABLE RECORDING MEDIUM STORING DATA PROCESSING PROGRAM, DATA PROCESSING DEVICE, AND DATA PROCESSING METHOD

(71) Applicant: FUJITSU LIMITED, Kawasaki-shi (JP)

(72) Inventors: Yoshiyuki Sakamaki, Kawasaki (JP); Kenji Hikichi, Kawasaki (JP); Yiyue Jiang, Kawasaki (JP)

(73) Assignee: FUJITSU LIMITED, Kawasaki-shi (JP)

(21) Appl. No.: 17/341,432

(22) Filed: Jun. 8, 2021

(30) Foreign Application Priority Data
Sep. 9, 2020 (JP) 2020-151009

(51) Int. Cl. G06F 16/245; G06F 16/248; G06Q 30/02

(52) U.S. Cl. CPC G06F 16/245; G06Q 30/0201; G06F 16/248

(57) ABSTRACT

A non-transitory computer-readable recording medium stores a data processing program for causing a computer to execute processing including: specifying one of boundaries between two adjacent attributes in processing target table data on the basis of association information that indicates a combination of two associated attributes among a plurality of attributes generated by analyzing analysis target table data that includes an attribute value of each of the plurality of attributes; and outputting boundary information that indicates the one of boundaries.

### CROSS-REFERENCE TO RELATED APPLICATION

This application is based upon and claims the benefit of priority of the prior Japanese Patent Application No. 2020-151009, filed on Sep. 9, 2020, the entire contents of which are incorporated herein by reference.

### FIELD

The embodiment discussed herein is related to data processing.

### BACKGROUND

In data analysis or machine learning, table data such as a relational database (RDB) is used. The table data often includes an attribute value of each of a plurality of attributes. The attribute included in the table data is also referred to as a column or an item.

Japanese Laid-open Patent. Publication No. 2015-26188, Japanese Laid-open Patent Publication No. 2008-181459, U.S. Patent Application Publication No. 2015/0324346, Japanese Laid-open Patent Publication No. 2014-85926, Toshihiro Kamishima, “Frequent Pattern Mining”, [online], Internet <URL:http://www.kamishima.net/archive/freqpat.pdf>, [Searched on May 25, 2020], and Rakesh Agrawal and Ramakrishnan Srikant, “Fast algorithms for mining association rules”, Proceedings of the 20th International Conference on Very Large Data Bases, VLDB, pages 487-499, 1994 are disclosed as related art.

### SUMMARY

According to an aspect of the embodiments, a non-transitory computer-readable recording medium stores a data processing program for causing a computer to execute processing including: specifying one of boundaries between two adjacent attributes in processing target table data on the basis of association information that indicates a combination of two associated attributes among a plurality of attributes generated by analyzing analysis target table data that includes an attribute value of each of the plurality of attributes; and outputting boundary information that indicates the one of boundaries.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a method for estimating a division position on the basis of an operation history;

FIG. 2 is a functional configuration diagram of a data processing device;

FIG. 3 is a flowchart of data processing;

FIG. 4 is a functional configuration diagram illustrating a first specific example of the data processing device;

FIGS. 5A to 5D are diagrams illustrating analysis target table data in the first specific example;

FIG. 6 is a diagram illustrating an attribute set;

FIGS. 7A to 7C are diagrams illustrating a window set on an attribute data string;

FIG. 8 is a diagram illustrating basket data;

FIG. 9 is a diagram illustrating a correlation rule;

FIGS. 10A to 10D are diagrams illustrating a window set on processing target table data;

FIG. 11 is a flowchart of correlation rule generation processing;

FIG. 12 is a flowchart of first division position detection processing;

FIG. 13 is a functional configuration diagram illustrating a second specific example of the data processing device;

FIG. 14 is a functional configuration diagram illustrating a third specific example of the data processing device;

FIG. 15 is a diagram illustrating attribute value information;

FIGS. 16A to 16E are diagrams illustrating analysis target table data in the third specific example;

FIGS. 17A to 17E are diagrams illustrating attribute types determined using the attribute value information;

FIGS. 18A to 18H are diagrams illustrating determination processing;

FIG. 19 is a diagram illustrating a digraph;

FIG. 20 is a diagram illustrating a division position in the processing target table data;

FIG. 21 is flowchart of digraph generation processing;

FIG. 22 is a flowchart of second division position detection processing;

FIG. 23 is a diagram illustrating determination processing in a case where a predetermined range is expanded;

FIG. 24 is a diagram illustrating a digraph in a case where the predetermined range is expanded;

FIG. 25 is a diagram illustrating a division position in processing target table data in a case where the predetermined range is expanded; and

FIG. 26 is a hardware configuration diagram of an information processing device.

### DESCRIPTION OF EMBODIMENTS

For example, table data of a customer master includes attributes such as a last name, a first name, an address, or a phone number of a customer, and table data of a sales history includes attributes such as a product name or a manufacturer of a product to be sold. There is table data that includes attributes of both of the customer master and the sales history.

A user who analyzes data or performs machine learning using the table data takes more time for a work for understanding relationships between the attributes included in the table data. The work for understanding the relationships between the attributes includes, for example, a work for estimating, as a division position of information, a boundary between two columns including different types of information among boundaries between two columns included in the table data. For example, the attribute of the customer master and the attribute of the sales history are different types of information.

In association with data processing on the table data, a database analyzer that calculates a data group categorization method from a correlation rule related to an attribute value and reconstructs the correlation rule has been known. A table classification device that classifies tables on the basis of similarity between tables in an easy-to-understand manner for a user has also been known.

A data analysis server that generates a synthetic spreadsheet by using columns of a plurality of spreadsheets that coincide with each other to integrate these spreadsheets has also been known. A database analyzer that generates a data pattern obtained by classifying a data group of a database on the basis of a feature in a data column unit has also been known. Frequent pattern mining that exemplifies patterns that satisfy constraints and exist in a database at a high frequency has also been known.

When a user performs a work for estimating a division position of information included in table data, if candidates of the division position are automatically presented, a work efficiency is improved.

In one aspect, a division position of information included in table data may be detected.

Hereinafter, embodiments will be described in detail with reference to the drawings.

The data analysis server in U.S. Patent Application Publication No. 2015/0324346 holds a user's operation performed on a plurality of spreadsheets or a synthetic spreadsheet as an operation history and applies the same operation to other spreadsheets.

When a relationship between attributes included in table data is understood, by using the operation history generated by the data analysis server in U.S. Patent Application Publication No. 2015/0324346, it is possible to estimate a division position of information in the table data.

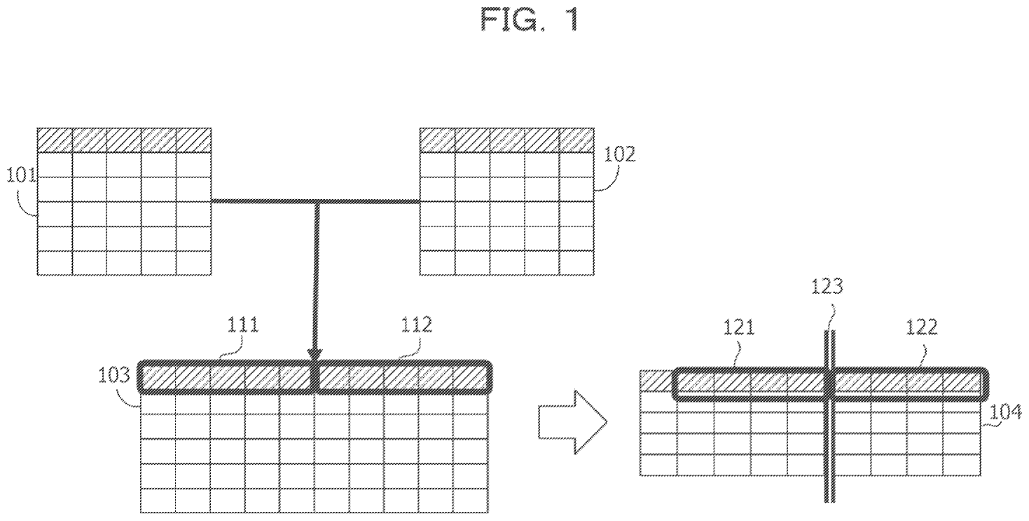

FIG. 1 illustrates an example of a method for estimating the division position on the basis of the operation history. In a case where a user combines table data 101 of a customer master and table data 102 of a sales history to generate synthesis table data 103, an operation for combining the table data 101 and the table data 102 is acquired as an operation history. Then, each of a combination of attributes 111 related to a customer corresponding to each column of the table data 101 and a combination of attributes 112 related to a product corresponding to each column of the table data 102 is held as an attribute cluster.

Next, an attribute is extracted from table data 104 to be estimated and the extracted attribute is compared with the attributes included in the attribute cluster so that a boundary 123 between an attribute 121 related to the customer and an attribute 122 related to the product is estimated as a division position of the information.

However, in the estimation method in FIG. 1, only in case where the operation for combining two pieces of table data having different types of information is performed and the operation history is held, it is possible to estimate the division position of these pieces of information. Therefore, it is difficult to estimate a division position of information in table data of which an operation history is unknown.

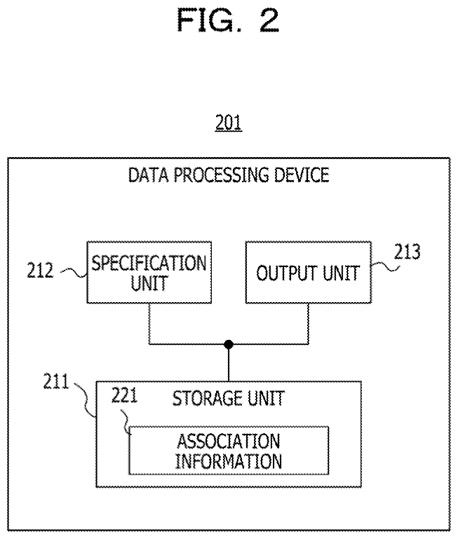

FIG. 2 illustrates a functional configuration example of a data processing device according to an embodiment. A data processing device 201 in FIG. 2 includes a storage unit 211, a specification unit 212, and an output unit 213. The storage unit 211 stores association information 221. The association information 221 is generated by analyzing analysis target table data including an attribute value of each of the plurality of attributes and indicates a combination of two attributes associated with each other among the plurality of attributes.

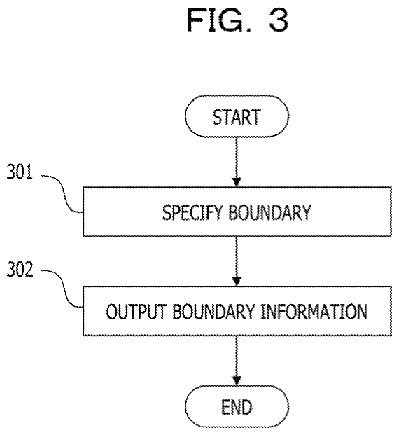

FIG. 3 is a flowchart illustrating an example of data processing executed by the data processing device 201 in FIG. 2. The specification unit 212 specifies one of boundaries between two adjacent attributes in the processing target table data on the basis of the association information 221 (step 301). The output unit 213 outputs boundary information indicating the specified boundary (step 302).

According to the data processing device 201 in FIG. 2, it is possible to detect the division position of the information included in the table data.

The attributes included in the table data are often arranged in an order that is easily understood by humans. In particular, for example, a plurality of attributes that are highly associated with each other are often arranged at positions close to each other in the table data. In this way, the attribute arrangement order has a certain regularity.

For example, there is a case where attributes are arranged in an order such as “last name/first name/gender/date of birth/address” in the table data related to the customer. However, the attributes related to the customer are rarely arranged in an order of “last name/date of birth/gender/first name/address”. Regarding table data that includes both of the attributes related to the customer and the attributes related to the product, an arrangement order of the attributes related to the customer is often determined as “last name/first name/gender/date of birth/address/product name/ . . . ” or “last name/first name/gender/date of birth/address/date and time of visit/ . . . ”.

In a case where an attribute that deviates from a rule of the arrangement order appears in the table data, the type of the attribute changes at that position. For example, in the arrangement of “last name/first name/gender/date of birth/address/product name/ . . . ”, “product name” corresponds to the attribute that deviates from the rule, and the boundary between “address” and “product name” is a division position of the information. Furthermore, in the arrangement of “last name/first name/gender/date of birth/address/date and time of visit/ . . . ”, “date and time of visit” corresponds to the attribute that deviates from the rule, and the boundary between “address” and “date and time of visit” is a division position of the information.

Therefore, by extracting the rule of the attribute arrangement order by analyzing the analysis target table data and specifying a position where the attribute that deviates from the rule appears in the processing target table data, it is possible to detect a division position of the information. A method such as machine learning can be used to analyze the analysis target table data.

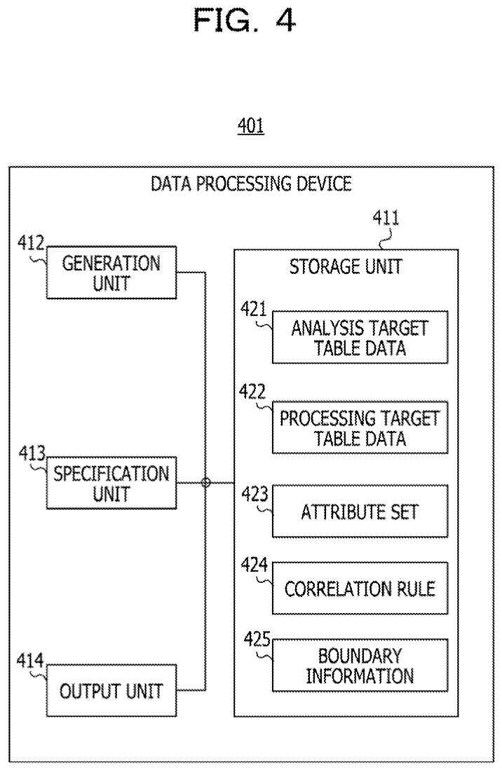

FIG. 4 illustrates a first specific example of the data processing device 201 in FIG. 2. A data processing device 401 in FIG. 4 includes a storage unit 411, a generation unit 412, a specification unit 413, and an output unit 414. The storage unit 411, the specification unit 413, and the output unit 414 correspond to the storage unit 211, the specification unit 212, and the output unit 213, respectively, in FIG. 2. The storage unit 411 stores one or more pieces of analysis target table data 421 and processing target table data 422.

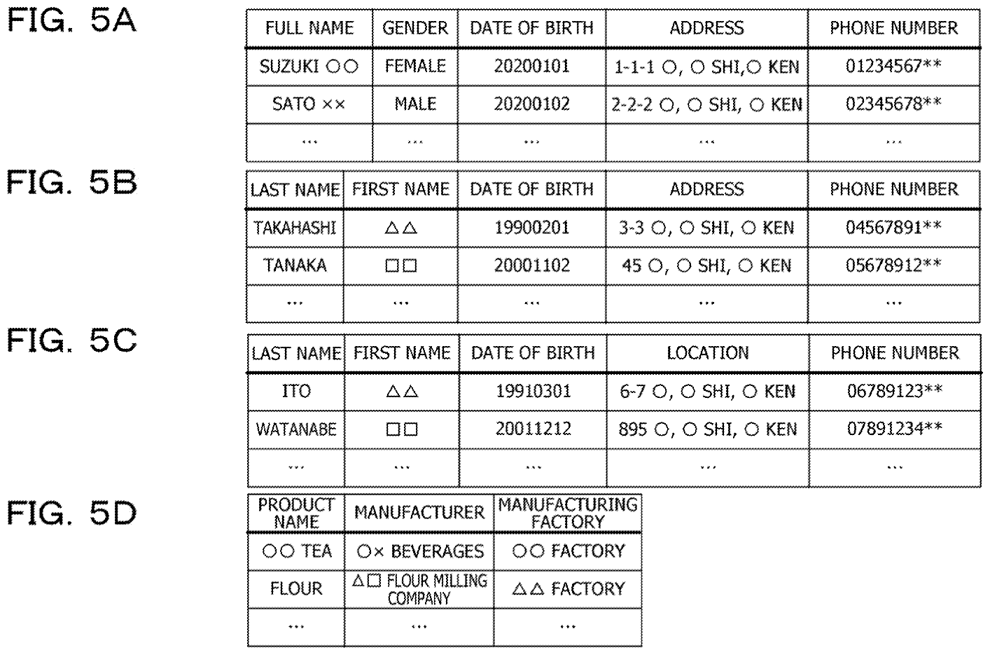

FIGS. 5A to 5D illustrate examples of the analysis target table data 421. FIGS. 5A to 5C illustrate examples of table data of the customer master. The table data in FIG. 5A includes “full name”, “gender”, “date of birth”, “address”, and “phone number” as attributes, and each column includes a plurality of attribute values. For example, “Suzuki ○○” and “Sato xx” are attribute values of “full name”.

The table data in FIG. 5B includes “last name”, “first name”, “date of birth”, “address”, and “phone number” as attributes, and each column includes a plurality of attribute values. The table data in FIG. 5C includes “last name”, “first name”, “date of birth”, “location”, and “phone number” as attributes, and each column includes a plurality of attribute values.

FIG. 5D illustrates an example of table data of the sales history. The table data in FIG. 5D includes “product name”, “manufacturer”, and “manufacturing factory” as attributes, and each column includes a plurality of attribute values.

The generation unit 412 extracts an attribute name from one or more pieces of analysis target table data 421, generates an attribute set 423 including the extracted attribute name, and stores the attribute set 423 in the storage unit 411.

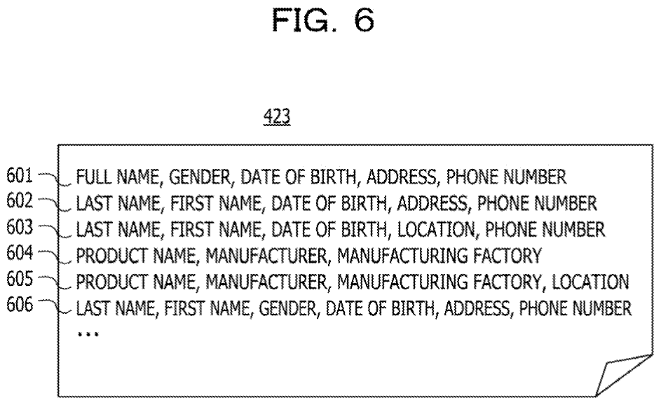

FIG. 6 illustrates an example of the attribute set 423 generated from the plurality of pieces of analysis target table data 421 including the table data in FIGS. 5A to 5D. The attribute set 423 in FIG. 6 includes attribute data strings 601 to 606.

The attribute data string 601 includes attribute names extracted from the table data in FIG. 5A, and the attribute data string 602 includes attribute names extracted from the table data in FIG. 5B. The attribute data string 603 includes attribute names extracted from the table data in FIG. 5C, and the attribute data string 604 includes attribute names extracted from the table data in FIG. 5D.

The attribute data strings 605 and 606 include attribute names extracted from other table data. An order of the attributes in each attribute data string is the same as the attribute arrangement order in the table data that is an extraction source. Therefore, the attribute arrangement order in the analysis target table data 421 is reflected to the attribute set 423.

Next, the generation unit 412 generates a correlation rule 424 that indicates a combination of two attributes associated with each other among the attributes included in the attribute set 423 through association analysis or the like and stores the correlation rule 424 in the storage unit 411. By generating the correlation rule 424 using the attribute set 423, a positional relationship between the plurality of attributes in the analysis target table data 421 can be reflected to the correlation rule 424. The correlation rule 424 corresponds to the association information 221 in FIG. 2.

As the association analysis, for example, basket analysis described in Toshihiro Kamishima, “Frequent Pattern Mining”, [online], Internet <URL:http://www.kamishima.net/archive/freqpat.pdf>, [Searched on May 25, 2020], and Rakesh Agrawal and Ramakrishnan Srikant, “Fast algorithms for mining association rules”, Proceedings of the 20th International Conference on Very Large Data Bases, VLDB, pages 487-499, 1994 can be used. In this case, the generation unit 412 sets a window that indicates a predetermined range on each attribute data string in the attribute set 423 and acquires attributes included in the window while shifting the window. The size of the window can be optionally set.

The generation unit 412 assumes the plurality of attributes acquired from the window at each position as transactions, assumes a list of the transactions acquired from the windows at all positions as the basket data, and performs basket analysis using the Apriori algorithm.

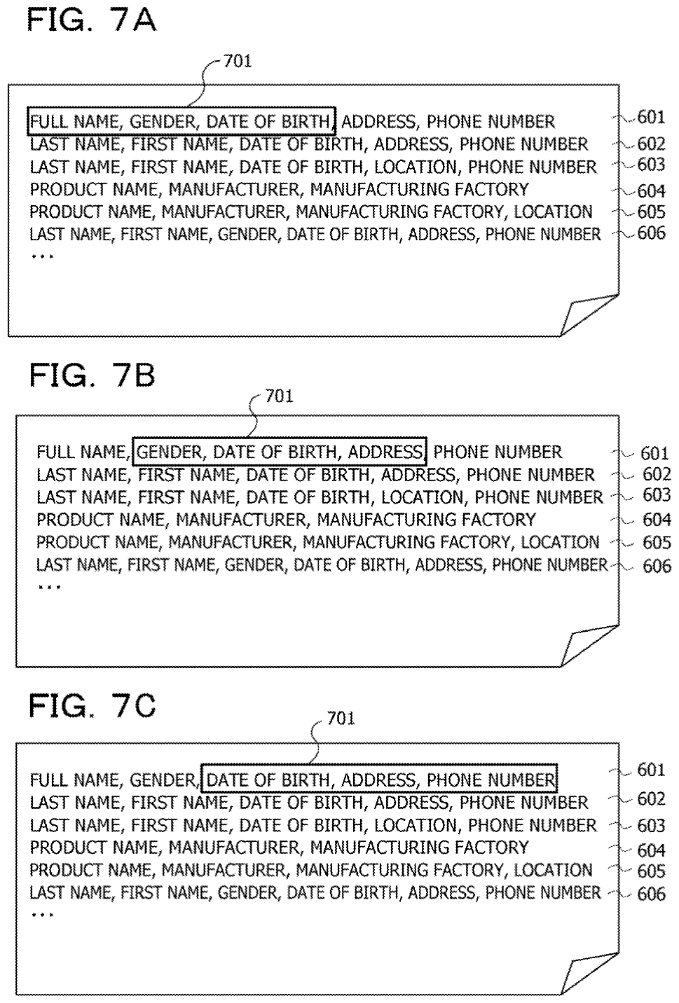

FIGS. 7A to 7C illustrate examples of a window set on the attribute data string 601 in FIG. 6. A size of a window 701 is three, and the window 701 can include three attributes. FIG. 7A illustrates the window 701 set at the left end of the attribute data string 601. From the window 701 in FIG. 7A, a combination of “full name”, “gender”, and “date of birth” is acquired as a transaction.

FIG. 7B illustrates the window 701 shifted from the left end of the attribute data string 601 to the right by one. From the window 701 in FIG. 7B, a combination of “gender”, “date of birth”, and “address” is acquired as a transaction.

FIG. 7C illustrates the window 701 shifted from the left end of the attribute data string 601 to the right by two. From the window 701 in FIG. 7C, a combination of “date of birth”, “address”, and “phone number” is acquired as a transaction.

Similarly, the generation unit 412 acquires three attributes in the window 701 at each position as a transaction while shifting the window 701 on each attribute data string.

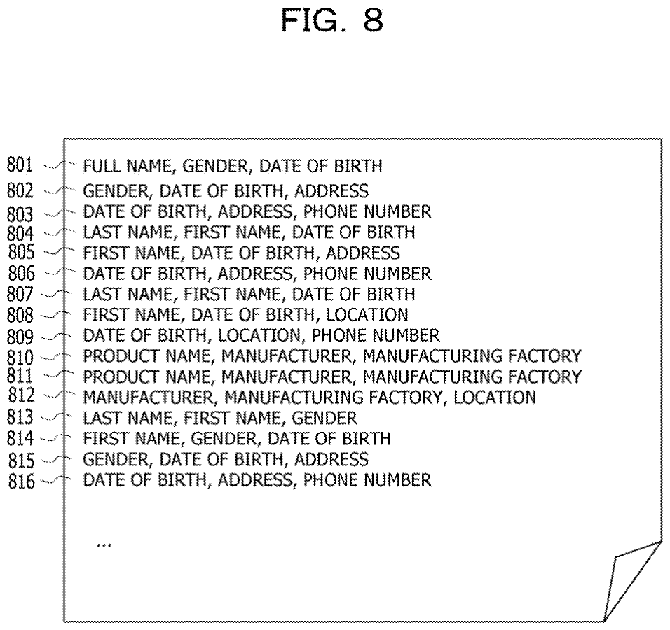

FIG. 8 illustrates an example of the basket data generated from the attribute set 423 in FIG, 6. The basket data in FIG. 8 includes transactions 801 to 816. The transactions 801 to 803 are transactions acquired from the attribute data string 601, and the transactions 804 to 806 are transactions acquired from the attribute data string 602.

The transactions 807 to 809 are transactions acquired from the attribute data string 603, and the transaction 810 is a transaction acquired from the attribute data string 604.

The transactions 811 and 812 are transactions acquired from the attribute data string 605, and the transactions 813 to 816 are transactions acquired from the attribute data string 606.

The correlation rule 424 is expressed as X→Y using conditions X and Y. In the basket analysis, a subset of the attributes included in any one of the transactions can be used as the conditions X and Y. In this case, Support (X) that indicates a degree of support and Confidence (X, Y) that indicates a degree of confidence are calculated using the following formulas.

Support (X)=N (X)/NT (1)

Confidence (X, Y)=N (X, Y)/N (X) (2)

NT represents the total number of transactions included in the basket data, N (X) represents the number of transactions that satisfy the condition X, and N (X, Y) represents the number of transactions that satisfy the conditions X and Y. The transaction that satisfies the condition X represents a transaction that includes the condition X as a subset. The transaction that satisfies the conditions X and Y represents a transaction that includes X∪Y as a subset. Therefore, N (X, Y)=N (X∪Y) is satisfied.

With the Apriori algorithm, a correlation rule X→Y that satisfies the following conditions is generated from the basket data.

Support (X∪Y)≥TH1 (3)

Confidence (X, Y)≥TH2 (4)

TH1 is a threshold representing the minimum degree of support, and TH2 is a threshold representing the minimum degree of confidence, TH1 and TH2 can be optionally set. Support (X∪Y) and Confidence (X, Y) represent a frequency at which a combination of a plurality of attributes included in X∪Y exists in a window in the attribute set 423.

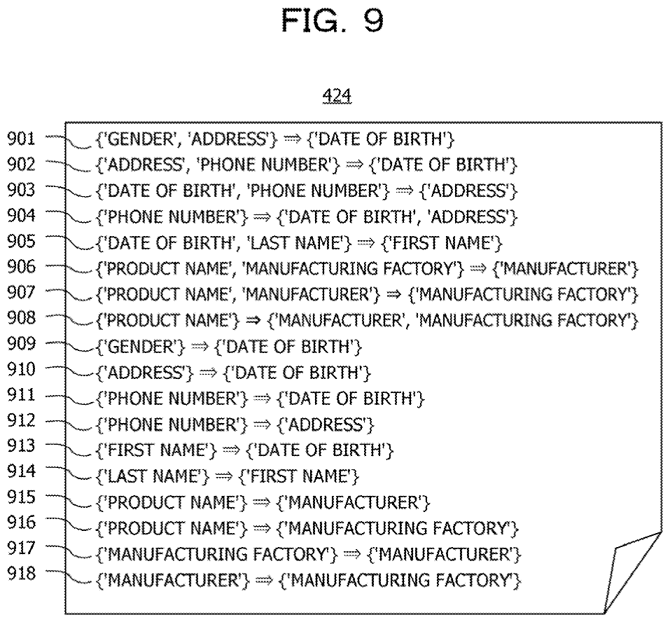

FIG. 9 illustrates an example of the correlation rule 424 generated from the basket data in FIG. 8. In this example, a case is assumed where the basket data includes only the transactions 801 to 816 and TH1=0.1 and TH2=0.7 are satisfied. Therefore, NT=16. Correlation rules 901 to 918 in FIG. 9 correspond to the correlation rule 424,

For example, in a case where X={‘gender’, ‘address’} and Y={‘date of birth’}, X∪Y={‘gender’, ‘address’, ‘date of birth’} is satisfied. In this case, Support (X∪Y) and Confidence (X, Y) are calculated using the following formulas.

$$\begin{matrix}Support ( X ⋃ Y ) = N ( X ⋃ Y ) / NT = 2 / 16 = 0.125 > 0.1 & ( 5 ) \\ Confidence ( X , Y ) = N ( X ⋃ Y ) / N ( X ) = 2 / 2 = 1.0 > 0.7 & ( 6 )\end{matrix}$$

Therefore, because the formulas (3) and (4) are satisfied, {‘gender’, ‘address’}→{‘date of birth’} is generated as the correlation rule 901.

Next, in a case where X={‘address’, ‘phone number’} and Y={‘date of birth’}, X∪Y={‘address’, ‘phone number’, ‘date of birth’} is satisfied. In this case, Support (X∪Y) and Confidence (X, Y) are calculated using the following formulas.

$$\begin{matrix}Support ( X ⋃ Y ) = N ( X ⋃ Y ) / NT = 3 / 16 = 0.1875 > 0.1 & ( 7 ) \\ Confidence ( X , Y ) = N ( X ⋃ Y ) / N ( X ) = 3 / 3 = 1.0 > 0.7 & ( 8 )\end{matrix}$$

Therefore, because the conditions of the formulas (3) and (4) are satisfied, {‘address’, ‘phone number’}→{‘date of birth’} is generated as the correlation rule 902. The correlation rules 903 to 918 are similarly generated.

By using the association analysis, a combination of two attributes, which exist in the window at a high frequency, in the attribute set 423 can be extracted as the correlation rule 424, and accuracy of the correlation rule 424 is improved. For example, “gender” and “date of birth” included in the correlation rule 901 correspond to the two attributes which exist in the window at a high frequency. Also, “address” and “date of birth” included in the correlation rule 901 correspond to the two attributes which exist in the window at a high frequency.

The specification unit 413 specifies a boundary corresponding to the division position of the information from among boundaries between the two attributes included in the processing target table data 422 using the correlation rule 424. Then, the specification unit 413 generates boundary information 425 indicating the specified boundary and stores the boundary information 425 in the storage unit 411. The output unit 414 outputs the boundary information 425.

For example, the specification unit 413 sets a window in a size as large as the window used to generate the basket data on the processing target table data 422, and acquires attributes included in the window while shifting the window. Then, the specification unit 413 specifies an attribute included in a left region and an attribute included in a right region for each of the plurality of boundaries included in the window. The left region represents a region on the left side of the boundary in the region in the window, the right region represents a region on the right side of the boundary in the region in the window.

Next, the specification unit 413 checks whether or not the correlation rule 424 exists between an attribute in the left region and an attribute in the right region. In a case where one of the attribute in the left region and the attribute in the right region belongs to the condition X of the correlation rule 424 and the other attribute belongs to the condition Y of the correlation rule 424, the specification unit 413 determines that the correlation rule 424 exists between the attributes.

In a case where any correlation rule 424 exists between the attribute in the left region and the attribute in the right region, the specification unit 413 determines that the boundary between the left region and the right region is not the division position, and in a case where no correlation rule 424 exists, the specification unit 413 determines that the boundary is the division position. This makes it possible to specify the boundary between the two attributes that are not associated with each other as a division position.

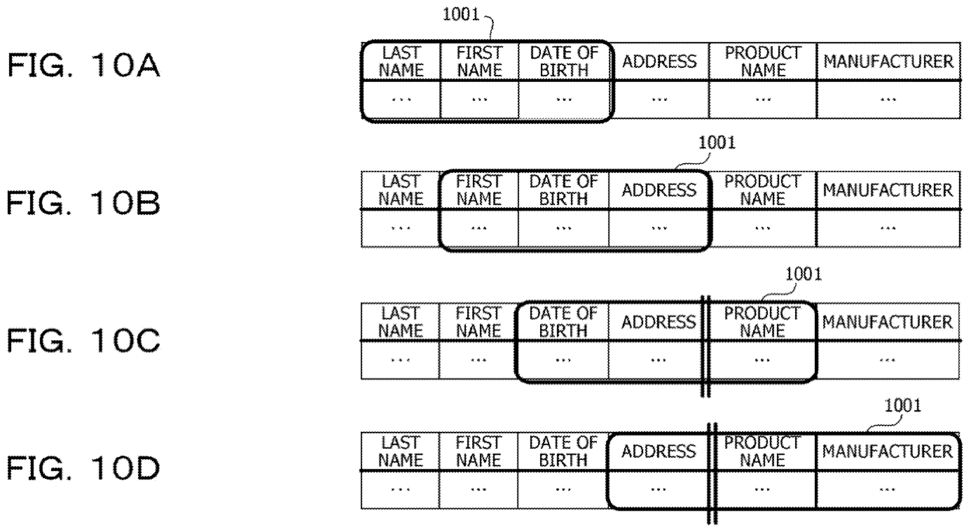

FIGS. 10A to 10D illustrate examples of a window set on the processing target table data 422. A size of a window 1001 is three, and the window 1001 can include three attributes.

FIG. 10A illustrates the window 1001 set at the left end of the processing target table data 422. From the window 1001 in FIG. 10A, “last name”, “first name”, and “date of birth” are acquired. The correlation rules 905 and 914 in FIG. 9 exist between “last name” and “first name”, and the correlation rules 905 and 913 exist between “first name” and “date of birth”. Therefore, there is no division position in the window 1001 in FIG. 10A.

FIG. 10B illustrates the window 1001 shifted from the left end of the processing target table data 422 to the right by one. From the window 1001 in FIG. 10B, “first name”, “date of birth”, and “address” are acquired. The correlation rules 905 and 913 exist between “first name” and “date of birth”, and the correlation rules 901 to 903 and 910 exist between “date of birth” and “address”. Therefore, there is no division position in the window 1001 in FIG. 10B.

FIG. 10C illustrates the window 1001 shifted from the left end of the processing target table data 422 to the right by two. From the window 1001 in FIG. 10C, “date of birth”, “address”, and “product name” are acquired. The correlation rules 901 to 903 and 910 exist between “date of birth” and “address”. However, the correlation rules 901 to 918 do not exist between “address” and “product name”, and the correlation rules 901 to 918 do not exist between “date of birth” and “product name”. Therefore, a boundary between “address” and “product name” is selected as a candidate of the division position.

FIG. 10D illustrates the window 1001 shifted from the left end of the processing target table data 422 to the right by three. From the window 1001 in FIG. 10D, “address”, “product name”, and “manufacturer” are acquired. The correlation rules 901 to 918 do not exist between “address” and “product name”, and the correlation rules 901 to 918 do not exist between “address” and “manufacturer”. The correlation rules 906, 908, and 915 exist between “product name” and “manufacturer”. Therefore, a boundary between “address” and “product name” is selected as a candidate of the division position again.

In this case, because the boundary between “address” and “product name” is selected as a candidate in the window 1001 at two consecutive positions, this boundary is specified as a division position.

Note that, when it is assumed that a correlation rule {‘manufacturer’}→{‘address’} be included in the correlation rule 424 in FIG. 9, the correlation rule exists between “address” and “manufacturer” in the window 1001 in FIG. 10D. Therefore, the boundary between “address” and “product name” is excluded from the candidates of the division position.

According to the data processing device 401 in FIG. 4, by analyzing the analysis target table data 421, the attribute set 423 reflecting the attribute arrangement order that is easily understood by humans is generated, and the correlation rule 424 that indicates a combination of two attributes associated with each other is generated from the attribute set 423. By using the generated correlation rule 424, it is possible to accurately detect the division position of the information even from the processing target table data 422 of which the operation history is unknown.

For example, in a case where the output unit 414 is a display device, the output unit 414 displays the processing target table data 422 on a screen and displays a parting line or the like at the division position indicated by the boundary information 425. As a result, a user can easily estimate the division position of the information included in the processing target table data 422.

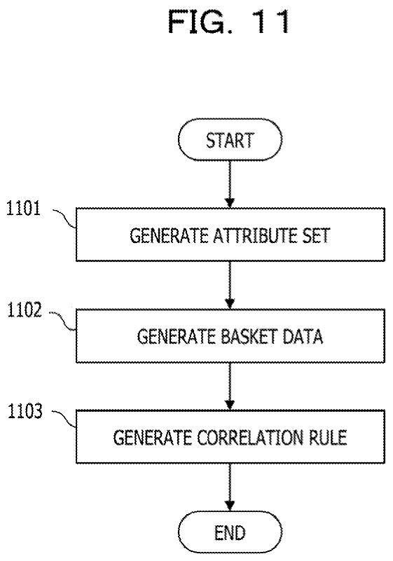

FIG. 11 is a flowchart illustrating an example of correlation rule generation processing executed by the data processing device 401 in FIG. 4. First, the generation unit 412 extracts an attribute name from one or more pieces of analysis target table data 421 and generates an attribute set 423 including the extracted attribute name (step 1101).

Next, the generation unit 412 sets a window on each attribute data string in the attribute set 423 and acquires attributes included in the window while shifting the window so as to generate basket data (step 1102). Then, the generation unit 412 generates a plurality of correlation rules 424 from the basket data using the Apriori algorithm (step 1103).

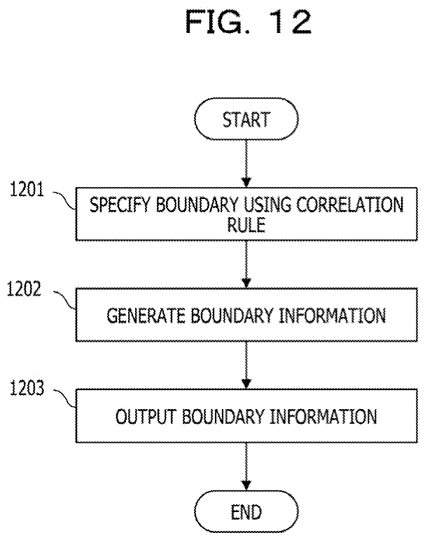

FIG. 12 is a flowchart illustrating an example of first division position detection processing executed by the data processing device 401 in FIG. 4. First, the specification unit 413 specifies a boundary corresponding to the division position of the information from among boundaries between the two attributes included in the processing target table data 422, using the correlation rule 424 (step 1201). Next, the specification unit 413 generates boundary information 425 indicating the specified boundary (step 1202), and the output unit 414 outputs the boundary information 425 (step 1203).

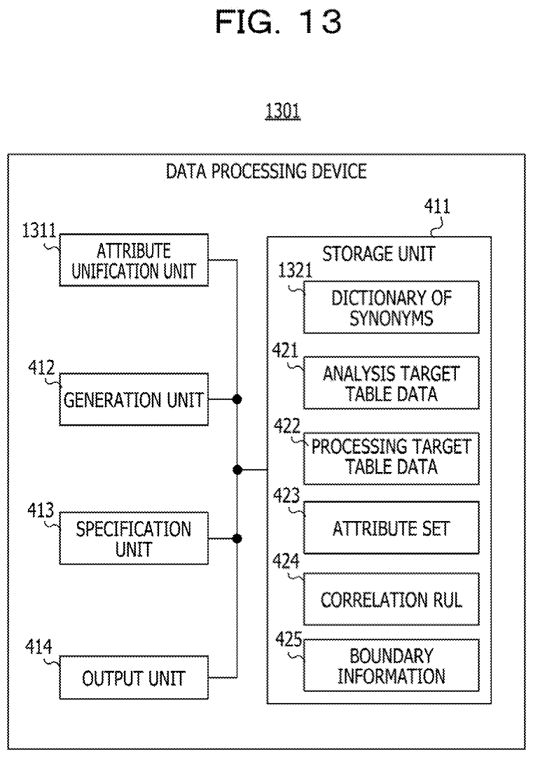

FIG. 13 illustrates a second specific example of the data processing device 201 in FIG. 2. A data processing device 1301 in FIG. 13 has a configuration in which an attribute unification unit 1311 is added to the data processing device 401 in FIG. 4. The storage unit 411 stores a dictionary of synonyms 1321 in addition to the one or more pieces of analysis target table data 421 and the processing target table data 422.

The dictionary of synonyms 1321 includes a plurality of representative words used as an attribute name and one or more synonyms similar to each representative word. For example, in a case where the representative word is “address”, “location” or the like is registered as a synonym of “address”.

The attribute unification unit 1311 extracts an attribute name from each piece of analysis target table data 421 and compares the extracted attribute name with the representative word and synonyms included in the dictionary of synonyms 1321. In a case where the extracted attribute name matches a representative word, the attribute unification unit 1311 outputs the attribute name to the generation unit 412. On the other hand, in a case where the extracted attribute name matches a synonym, the attribute unification unit 1311 outputs a representative word associated with that synonym to the generation unit 412.

As a result, notational fluctuation in the attribute names extracted from the plurality of pieces of analysis target table data 421 is absorbed, and similar attribute names are unified into the representative word. The generation unit 412 generates the attribute set 423 and the correlation rule 424 using the attribute name output from the attribute unification unit 1311.

Furthermore, the attribute unification unit 1311 extracts an attribute name from each piece of processing target table data 422 and compares the extracted attribute name with the representative word and synonyms included in the dictionary of synonyms 1321. In a case where the extracted attribute name matches a representative word, the attribute unification unit 1311 outputs the attribute name to the specification unit 413. On the other hand, in a case where the extracted attribute name matches a synonym, the attribute unification unit 1311 outputs the representative word associated with the synonym to the specification unit 413.

The specification unit 413 specifies a boundary corresponding to the division position of the information in the processing target table data 422 on the basis of the correlation rule 424 using the attribute name output from the attribute unification unit 1311.

The synonyms included in the dictionary of synonyms 1321 may be synonyms estimated through natural language processing. As the natural language processing for estimating synonyms, for example, a word embedding technology for converting a word into a feature vector can be used.

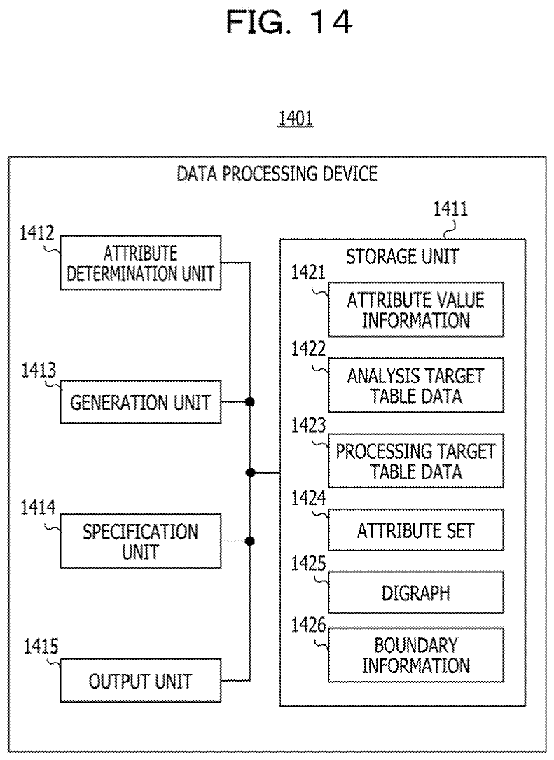

FIG. 14 illustrates a third specific example of the data processing device 201 in FIG. 2. A data processing device 1401 in FIG. 14 includes a storage unit 1411, an attribute determination unit 1412, a generation unit 1413, a specification unit 1414, and an output unit 1415. The storage unit 1411, the specification unit 1414, and the output unit 1415 correspond to the storage unit 211, the specification unit 212, and the output unit 213, respectively, in FIG. 2. The storage unit 1411 stores attribute value information 1421, one or more pieces of analysis target table data 1422 and processing target table data 1423.

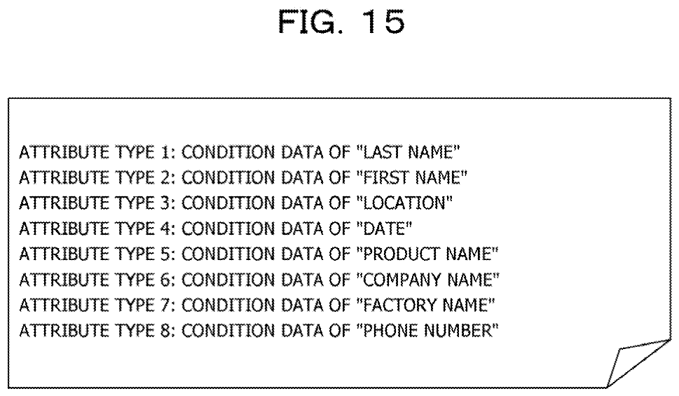

FIG. 15 illustrates an example of the attribute value information 1421. The attribute value information 1421 in FIG. 15 includes condition data corresponding to each of attribute types 1 to 8. The condition data of each attribute type is preset.

The attribute type 1 corresponds to the attribute “last name” and is associated with condition data of “last name”. In a case where a ratio of attribute values including a character string registered in a dictionary of “last name” among the plurality of attribute values of any attribute included in the table data is equal to or more than a threshold, the condition data of “last name” indicates that the attribute is “last name”. The dictionary of “last name” includes a plurality of character strings used as an attribute value of “last name” such as “Suzuki”, “Nakamura”, “Sato”, or the like. The threshold may be a value in a range of 70% to 90%.

The attribute type 2 corresponds to the attribute “first name”, and is associated with condition data of “first name”. In a case where a ratio of attribute values including a character string registered in a dictionary of “first name” among the plurality of attribute values of any attribute included in the table data is equal to or more than the threshold, the condition data of “first name” indicates that the attribute is “first name”. The dictionary of “first name” includes a plurality of character strings used as an attribute value of “first name” such as “Taro”, “Hanako”, or the like.

The attribute type 3 corresponds to the attribute “location” and is associated with condition data of “location”. In a case where a ratio of attribute values including characters of “to”, “do”, “fu”, “ken”, “shi”, “ku”, “cho”, or “mura” among the plurality of attribute values of any attribute included in the table data is equal to or more than the threshold, the condition data of “location” indicates that the attribute is “location”.

The attribute type 4 corresponds to the attribute “date” and is associated with condition data of “date”. In a case where a plurality of attribute values of any attribute included in the table data includes all characters of “year”, “month,” and “day” or in a case where the attribute values forms a number string in a date format, the condition data of “date” indicates that the attribute is “date”. The number string in the date format may be “yyyymmdd” or “yyyy/mm/dd”. The number string “yyyy” represents a year, “mm” represents a month, and “dd” represents a day.

The attribute type 5 corresponds to the attribute “product name” and is associated with condition data of “product name”. In a case where a ratio of attribute values including a character string registered in a dictionary of “product name” among the plurality of attribute values of any attribute included in the table data is equal to or more than the threshold, the condition data of “product name” indicates that the attribute is “product name”. The dictionary of “product name” includes a plurality of character strings used as an attribute value of “product name” such as “tea”, “flour”, “jam”, “bread”, or the like.

The attribute type 6 corresponds to an attribute “company name” and is associated with condition data of “company name”. In a case where a ratio of attribute values including a character string registered in a dictionary of “company name” among the plurality of attribute values of any attribute included in the table data is equal to or more than the threshold, the condition data of “company name” indicates that the attribute is “company name”. The dictionary of “company name” includes a plurality of character strings used as an attribute value of “company name” such as “○○ Corporation”, “○○ Co., Ltd.”, “○○ manufacturing company”, or the like.

The attribute type 7 corresponds to an attribute “factory name” and is associated with condition data of “factory name”. In a case where a ratio of attribute values including a character string “factory” among the plurality of attribute values of any attribute included in the table data is equal to or more than the threshold, the condition data of “factory name” indicates that the attribute is “factory name”.

The attribute type 8 corresponds to the attribute “phone number” and is associated with condition data of “phone number”. In a case where the plurality of attribute values of any attribute included in the table data is a number string in a phone number format, the condition data of “phone number” indicates that the attribute is “phone number”. The number string in the phone number format may be “0*********”.

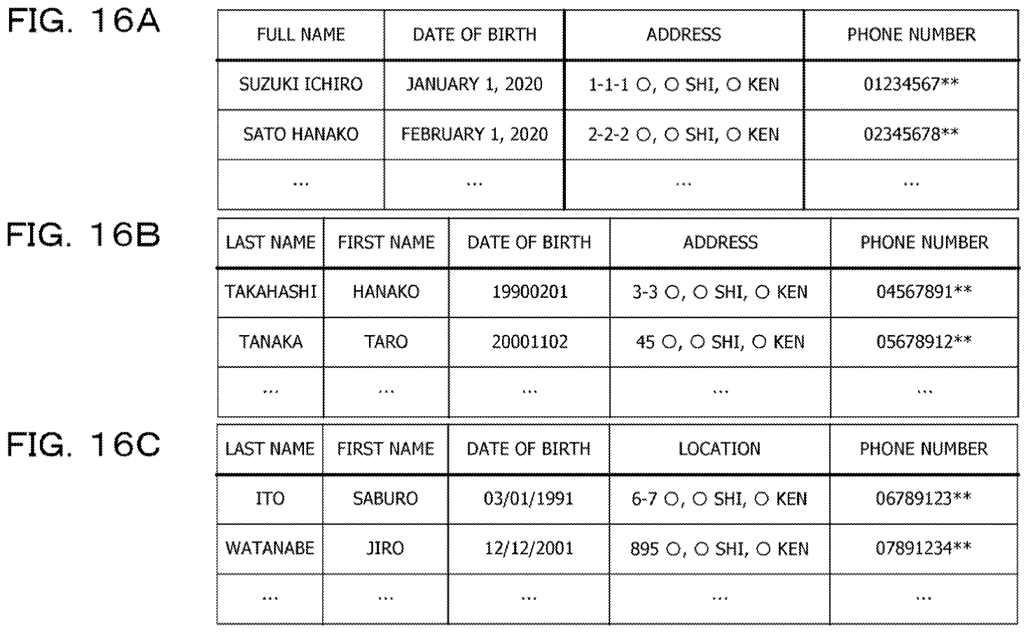

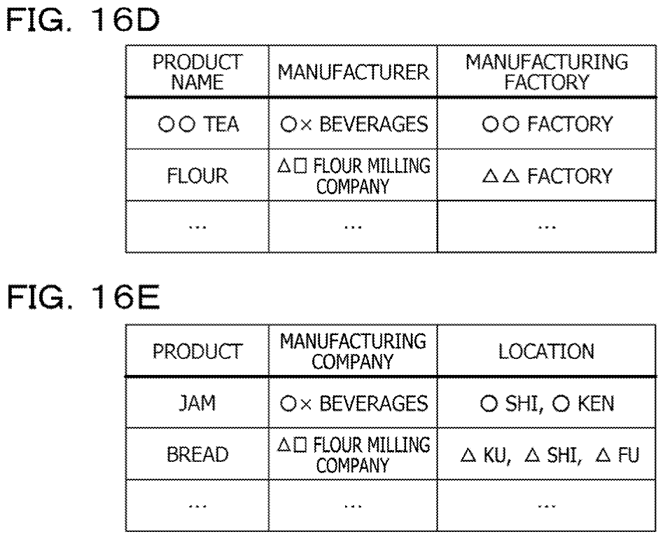

FIGS. 16A to 16E illustrate examples of the analysis target table data 1422. FIGS. 16A to 16C illustrate examples of table data of a customer master. The table data in FIG. 16A includes “full name”, “date of birth”, “address”, and “phone number” as attributes, and each column includes a plurality of attribute values.

The table data in FIG. 16B includes “family name”, “name”, date of birth”, “address”, and “phone number” as attributes, and each column includes a plurality of attribute values. The table data in FIG. 16C includes “last name”, “first name”, “date of birth”, “location”, and “phone number” as attributes, and each column includes a plurality of attribute values.

FIGS. 16D and 16E illustrate examples of table data of a sales history. The table data in FIG. 16D includes “product name”, “manufacturer”, and “manufacturing factory” as attributes, and each column includes a plurality of attribute values. The table data in FIG. 16E includes “product”, “manufacturing company”, and “location” as attributes, and each column includes a plurality of attribute values.

The attribute determination unit 1412 checks whether or not the plurality of attribute values belonging to each column of each piece of the analysis target table data 1422 satisfies the condition data of each attribute type registered in the attribute value information 1421. Then, the attribute determination unit 1412 determines the attribute type corresponding to the condition data satisfied by the plurality of attribute values as the attribute type of the column.

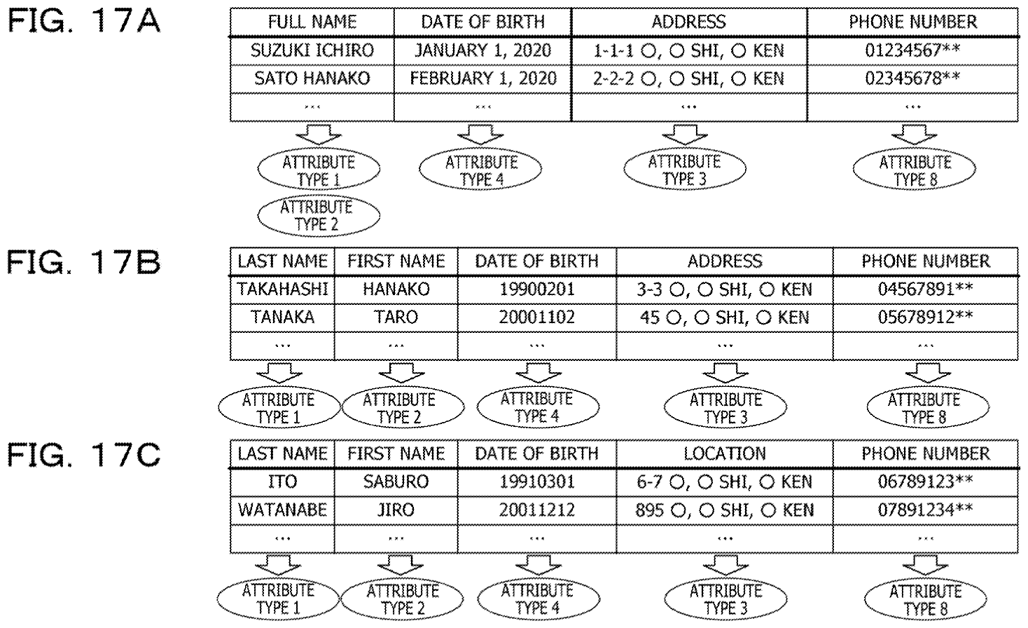

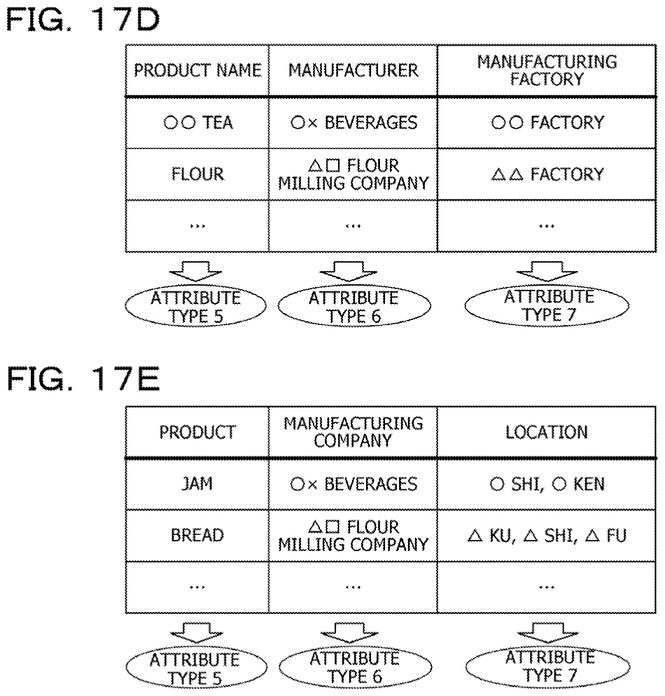

FIGS. 17A to 17E illustrate examples of the attribute type determined using the attribute value information 1421 in FIG. 15. FIGS. 17A to 17E illustrate examples of the attribute type determined with respect to the table data in FIGS. 16A to 16E, respectively.

Because a plurality of attribute values belonging to a column of “full name” in FIG. 17A satisfies the condition data of the attribute types 1 and 2, the attribute type of that column is determined as the attribute types 1 and 2. Because a plurality of attribute values belonging to a column of “date of birth” satisfies the condition data of the attribute type 4, the attribute type of that column is determined as the attribute type 4. Because a plurality of attribute values belonging to a column of “address” satisfies the condition data of the attribute type 3, the attribute type of that column is determined as the attribute type 3. Because a plurality of attribute values belonging to a column of “phone number” satisfies the condition data of the attribute type 8, the attribute type of that column is determined as the attribute type 8.

Similarly, an attribute type of a column of “family name” in FIG. 17B is determined as the attribute type 1, and an attribute type of a column of “name” is determined as the attribute type 2. An attribute type of a column of “date of birth” is determined as the attribute type 4, and an attribute type of a column of “address” is determined as the attribute type 3. An attribute type of a column of “phone number” is determined as the attribute type 8.

An attribute type of a column of “last name” in FIG. 17C is determined as the attribute type 1, and an attribute type of a column of “first name” is determined as the attribute type 2. An attribute type of a column of “date of birth” is determined as the attribute type 4, and an attribute type of a column of “location” is determined as the attribute type 3. An attribute type of a column of “phone number” is determined as the attribute type 8.

An attribute type of a column of “product name” in FIG. 17D is determined as the attribute type 5, and an attribute type of a column of “manufacturer” is determined as the attribute type 6. An attribute type of a column of “manufacturing factory” is determined as the attribute type 7.

An attribute type of a column of “product” in FIG. 17E is determined as the attribute type 5, and an attribute type of a column of “manufacturing company” is determined as the attribute type 6. An attribute type of a column of “location” is determined as the attribute type 3.

The attribute determination unit 1412 can determine the attribute type of each column of each piece of the analysis target table data 1422 using the data pattern described in Japanese Laid-open Patent Publication No. 2014-85926 instead of the attribute value information 1421.

The generation unit 1413 generates an attribute set 424 including attribute types of the plurality of attributes determined with respect to the one or more pieces of analysis target table data 1422 and stores the attribute set 1424 in the storage unit 1411.

For example, the attribute set 1424 generated from the table data in FIGS. 16A to 16E includes the attribute types 1 to 8 in FIGS. 17A to 17E. An order of the attribute types in the attribute set 1424 corresponds to the attribute arrangement order in the table data in FIGS. 16A to 16E. Therefore, the attribute arrangement order in the analysis target table data 1422 is reflected to the attribute set 1424.

Next, the generation unit 1413 generates a digraph 1425 that indicates a combination of two attributes associated with each other among the attributes included in the attribute set 1424 and stores the digraph 1425 in the storage unit 1411. By generating the digraph 1425 using the attribute set 1424, it is possible to reflect a positional relationship between the plurality of attributes in the analysis target table data 1422 to the digraph 1425. The digraph 1425 corresponds to the association information 221 in FIG. 2.

The digraph 1425 includes a node representing each attribute type included in the attribute set 1424 and an edge that connects two nodes. Each edge is represented by an arrow connecting two attribute types. The generation unit 1413 generates the digraph 1425 by connecting two attribute types which exist, at a high frequency, within a predetermined range in one or more pieces of analysis target table data 1422 among the attribute types included in the attribute set 1424 with an arrow.

As the predetermined range using an attribute type as a reference, for example, a reference column to which the attribute type belongs and an adjacent column adjacent to the reference column can be used. In this case, two attribute types associated with the reference column exist in the predetermined range, and two attribute types respectively associated with the reference column and the adjacent column also exist in the predetermined range.

For example, in a case where the analysis target table data 1422 stored in the storage unit 1411 is only the table data in FIGS. 16A to 16E, the attribute types included in the attribute set 1424 are the attribute types 1 to 8. Whether or not the frequency at which the two attribute types exist in the predetermined range is high is determined using a threshold TF.

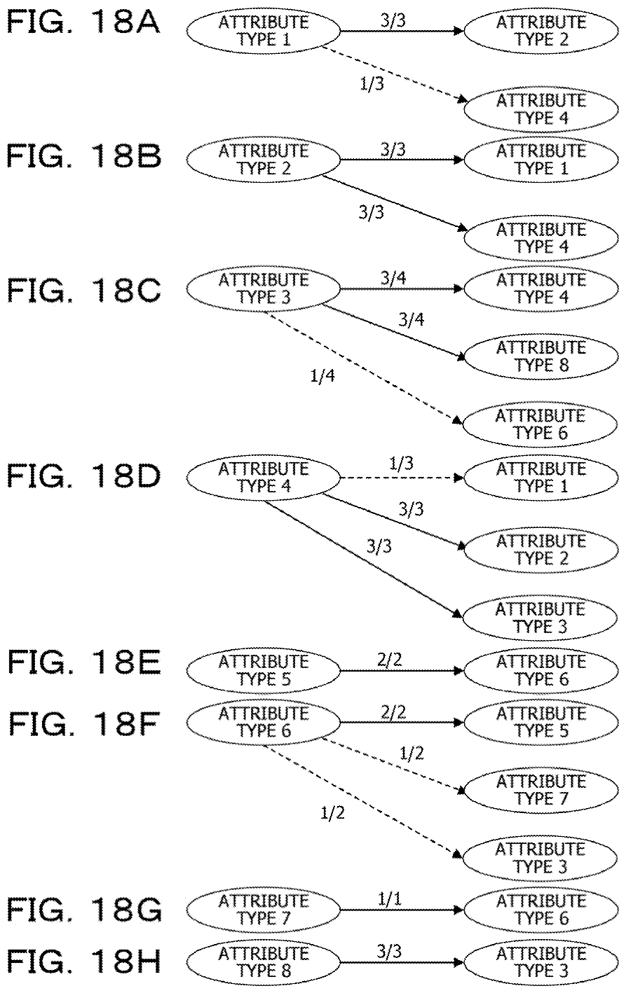

FIGS. 18A to 18H illustrate examples of determination processing for determining whether or not two attribute types are connected with an arrow. In this example, TF=0.5 is satisfied. The following table data (a) to (e) indicate the table data in FIGS. 16A to 16E, respectively.

In the determination processing in FIGS. 18A to 18H, a frequency F (i, j) (i, j=1 to 8) at which an attribute type j exists in a predetermined range using an attribute type i as a reference is used. In a case where F (i, j)>TF, the generation unit 1413 generates an arrow from the attribute type i toward the attribute type j; and, in a case where F (i, j)≤TF, the generation unit 1413 does not generate the arrow from the attribute type i toward the attribute type j.

FIG. 18A illustrates an example of determination processing using the attribute type 1 as a reference. In FIGS. 17A to 17E, other attribute types associated with the same column as the attribute type 1 or a column adjacent to the attribute type 1 are as follows.

Table data (a): attribute types 2 and 4

Table data (b); attribute type 2

Table data (c): attribute type 2

Table data (d): none

Table data (e): none

The attribute type 1 appears three times in total, and the attribute type 2 appears three times in the predetermined range using the attribute type 1 as a reference, and the attribute type 4 appears once. Therefore, a frequency F (1, 2) at which the attribute type 2 exists in the predetermined range and a frequency F (1, 4) at which the attribute type 4 exists in the predetermined range are calculated using the following formulas.

F (1, 2)=3/3>0.5 (11)

F (1, 4)=1/3<0.5 (12)

In this case, because F (1, 2)>TF and F (1, 4)<TF are satisfied, an arrow from the attribute type 1 toward the attribute type 2 is generated, and an arrow from the attribute type 1 toward the attribute type 4 is not generated.

FIG. 18B illustrates an example of determination processing using the attribute type 2 as a reference. In FIGS. 17A to 17E, other attribute types associated with the same column as the attribute type 2 or a column adjacent to the attribute type 2 are as follows.

Table data (a): attribute types 1 and 4

Table data (b): attribute types 1 and 4

Table data (c): attribute types 1 and 4

Table data (d): none

Table data (e): none

The attribute type 2 appears three times in total, the attribute type 1 appears three times in the predetermined range using the attribute type 2 as a reference, and the attribute type 4 appears three times. Therefore, a frequency F (2, 1) at which the attribute type 1 exists in the predetermined range and a frequency F (2, 4) at which the attribute type 4 exists in the predetermined range are calculated using the following formulas.

F (2, 1)=3/3>0.5 (13)

F (2, 4)=3/3>0.5 (14)

In this case, because F (2, 1)>TF and F (2, 4)>TF are satisfied, an arrow from the attribute type 2 toward the attribute type 1 and an arrow from the attribute type 2 toward the attribute type 4 are generated.

FIG. 18C illustrates an example of determination processing using the attribute type 3 as a reference. In FIGS. 17A to 17E, other attribute types associated with the same column as the attribute type 3 or a column adjacent to the attribute type 3 are as follows.

Table data (a): attribute types 4 and 8

Table data (b): attribute types 4 and 8

Table data (c): attribute types 4 and 8

Table data (d): none

Table data (e): attribute type 6

The attribute type 3 appears four times in total, the attribute type 4 appears three times in the predetermined range using the attribute type 3 as a reference, the attribute type 8 appears three times, and the attribute type 6 appears once. Therefore, a frequency F (3, 4) at which the attribute type 4 exists in the predetermined range, a frequency F (3, 8) at which the attribute type 8 exists in the predetermined range, and a frequency F (3, 6) at which the attribute type 6 exists in the predetermined range are calculated using the following formulas.

F (3, 4)=3/4>0.5 (15)

F (3, 8)=3/4>0.5 (16)

F (3, 6)=1/4<0.5 (17)

In this case, because F (3, 4)>TF, F (3, 8)>TF, and F (3, 6)<TF are satisfied, an arrow from the attribute type 3 toward the attribute type 4 and an arrow from the attribute type 3 toward the attribute type 8 are generated, and an arrow from the attribute type 3 toward the attribute type 6 is not generated.

FIG. 18D illustrates an example of determination processing using the attribute type 4 as a reference. In FIGS. 17A to 17E, other attribute types associated with the same column as the attribute type 4 or a column adjacent to the attribute type 4 are as follows.

Table data (a): attribute types 1, 2, and 3

Table data (b): attribute types 2 and 3

Table data (c): attribute types 2 and 3

Table data (d): none

Table data (e): none

The attribute type 4 appears three times in total, the attribute type 1 appears once in the predetermined range using the attribute type 4 as a reference, the attribute type 2 appears three times, and the attribute type 3 appears three times. Therefore, a frequency F (4, 1) at which the attribute type 1 exists in the predetermined range, a frequency F (4, 2) at which the attribute type 2 exists in the predetermined range, and a frequency F (4, 3) at which the attribute type 3 exists in the predetermined range are calculated using the following formulas.

F (4, 1)=1/3<0.5 (18)

F (4, 2)=3/3>0.5 (19)

F (4, 3)=3/3>0.5 (20)

In this case, because F (4, 1)<TF, F (4, 2)>TF, and F (4, 3)>TF are satisfied, an arrow from the attribute type 4 toward the attribute type 1 is not generated, and an arrow from the attribute type 4 toward the attribute type 2 and an arrow from the attribute type 4 toward the attribute type 3 are generated.

FIG. 18E illustrates an example of determination processing using the attribute type 5 as a reference. In FIGS. 17A to 17E, other attribute types associated with the same column as the attribute type 5 or a column adjacent to the attribute type 5 are as follows.

Table data (a): none

Table data (b); none

Table data (c): none

Table data (d): attribute type 6

Table data (e): attribute type 6

The attribute type 5 appears twice in total, and the attribute type 6 appears twice in the predetermined range using the attribute type 5 as a reference. Therefore, a frequency F (5, 6) at which the attribute type 6 exists n the predetermined range is calculated using the following formula.

F (5, 6)=2/2>0.5 (21)

In this case, because F (5, 6)>TF is satisfied, an arrow from the attribute type 5 toward the attribute type 6 is generated.

FIG. 18F illustrates an example of determination processing using the attribute type 6 as a reference. In FIGS. 17A to 17E, other attribute types associated with the same column as the attribute type 6 or a column adjacent to the attribute type 6 are as follows.

Table data (a): none

Table data (b); none

Table data (c): none

Table data (d): attribute types 5 and 7

Table data (e): attribute types 5 and 3

The attribute type 6 appears twice in total, the attribute type 5 appears twice in the predetermined range using the attribute type 6 as a reference, the attribute type 7 appears once, and the attribute type 3 appears once. Therefore, a frequency F (6, 5) at which the attribute type 5 exists in the predetermined range, a frequency F (6, 7) at which the attribute type 7 exists in the predetermined range, and a frequency F (6, 3) at which the attribute type 3 exists in the predetermined range are calculated using the following formulas.

F (6, 5)=2/2>0.5 (22)

F (6, 7)=1/2=0.5 (23)

F (6, 3)=1/2=0.5 (24)

In this case, F (6, 5)>TF, F (6, 7)≤TF, and F (6, 3)≤TF are satisfied, an arrow from the attribute type 6 toward the attribute type 5 is generated, and an arrow from the attribute type 6 toward the attribute type 7 and an arrow from the attribute type 6 toward the attribute type 3 are not generated.

FIG. 18G illustrates an example of determination processing using the attribute type 7 as a reference. In FIGS. 17A to 17E, other attribute types associated with the same column as the attribute type 7 or a column adjacent to the attribute type 7 are as follows.

Table data (a): none

Table data (b): none

Table data (c): none

Table data (d): attribute type 6

Table data (e): none

The attribute type 7 appears only once, and the attribute type 6 appears once in the predetermined range using the attribute type 7 as a reference. Therefore, a frequency F (7, 6) at which the attribute type 6 exists in the predetermined range is calculated using the following formula.

F (7, 6)=1/1>0.5 (25)

In this case, because F (7, 6)>TF is satisfied, an arrow from the attribute type 7 toward the attribute type 6 is generated.

FIG. 18H illustrates an example of determination processing using the attribute type 8 as a reference. In FIGS. 17A to 17E, other attribute types associated with the same column as the attribute type 8 or a column adjacent to the attribute type 8 are as follows.

Table data (a): attribute type 3

Table data (b): attribute type 3

Table data (c): attribute type 3

Table data (d): none

Table data (e): none

The attribute type 8 appears three times in total, and the attribute type 3 appears three times in the predetermined range using the attribute type 8 as a reference. Therefore, a frequency F (8, 3) at which the attribute type 3 exists in the predetermined range is calculated using the following formula.

F (8, 3)=3/3>0.5 (26)

In this case, because F (8, 3)>TF is satisfied, an arrow from the attribute type 8 toward the attribute type 3 is generated.

According to the determination processing in FIGS. 18A to 18H, two attribute types which exist, at a high frequency, within the predetermined range in the one or more pieces of analysis target table data 1422 can be connected with the arrow, and the accuracy of the digraph 1425 is improved.

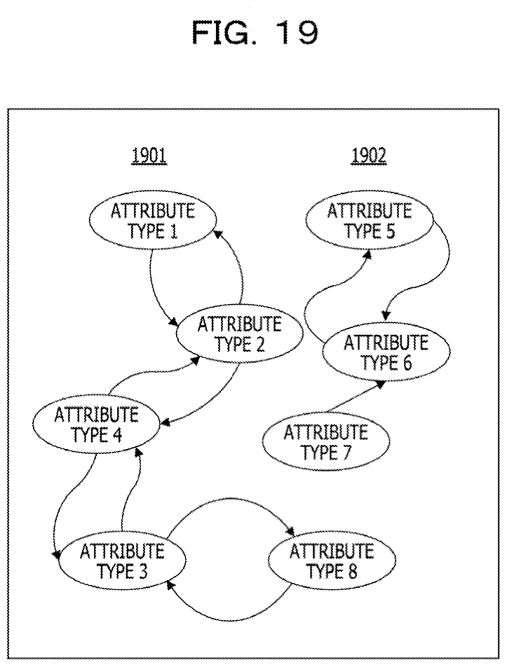

FIG. 19 illustrates an example of the digraph 1425 generated by the determination processing in FIGS. 18A to 18H. A digraph 1901 in FIG. 19 includes the attribute types 1 to 4 and 8, and a digraph 1902 includes the attribute types 5 to 7. In each digraph, two attribute types connected with any one of arrows correspond to the two attributes that exist, at a high frequency, in the predetermined range in the plurality of pieces of analysis target table data 1422, and indicate a combination of two attributes associated with each other.

The specification unit 1414 specifies a boundary corresponding to the division position of the information among boundaries between two attributes included in the processing target table data 1423, using the digraph 1425. Then, the specification unit 1414 generates boundary information 1426 indicating the specified boundary and stores the boundary information 1426 in the storage unit 1411. The output unit 1415 outputs the boundary information 1426.

For example, the specification unit 141.4 selects each column of the processing target table data 1423 in order from the left end as a processing target column, and compares an attribute type of the processing target column with an attribute type of a column on the right side of the processing target column. In a case where the two attribute types are the same attribute types, the specification unit 1414 determines that the attribute of the processing target column is associated with the attribute of the column on the right side of the processing target column.

In a case where the two attribute types are different attribute types from each other, the specification unit 1414 checks whether or not the attribute types are connected with the arrow in the digraph 1425. In a case where the two attribute types are connected with the arrow, the specification unit 1414 determines that the attribute of the processing target column is associated with the attribute of the column on the right side of the processing target column. On the other hand, in a case where the two attribute types are not connected with the arrow, the specification unit 1414 determines that the attribute of the processing target column is not associated with the attribute of the column on the right side of the processing target column.

In a case where the attributes of the two columns are associated with each other, the specification unit 1414 determines that the boundary between the columns is not the division position, and in a case where the attributes of the two columns are not associated with each other, the specification unit 1414 determines that the boundary between the columns is the division position. This makes it possible to specify the boundary between the two attributes that are not associated with each other as a division position.

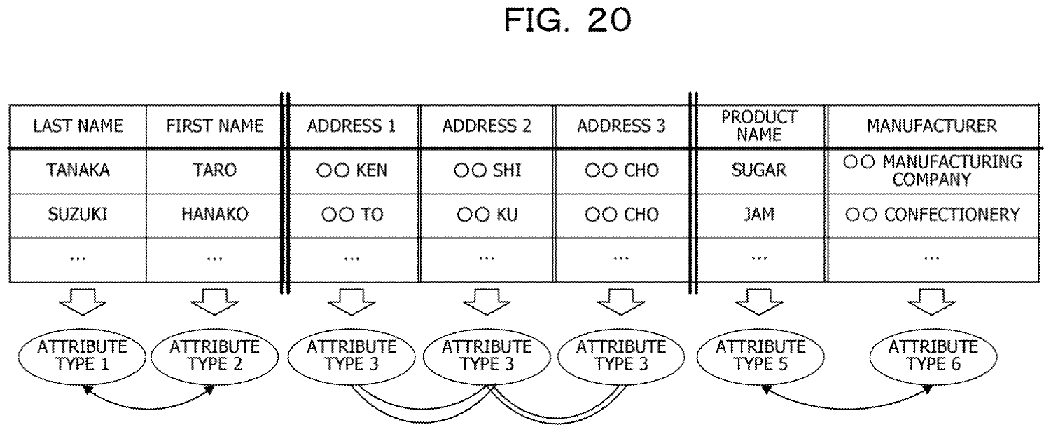

FIG. 20 illustrates an example of a division position in the processing target table data 1423. An attribute type of a column of “last name” in the processing target table data 1423 in FIG. 20 is determined as the attribute type 1, and an attribute type of a column of “first name” is determined as the attribute type 2. Attribute types of columns of “address 1”, “address 2”, and “address 3” are determined as the attribute type 3. An attribute type of a column of “product name” is determined as the attribute type 5, and an attribute type of a column of “manufacturer” is determined as the attribute type 6.

First, the column of “last name” is selected as the processing target column, and the attribute type 1 of the column of “last name” is compared with the attribute type 2 of the column of “first name”. In the digraph 1901, because the attribute type 1 is connected to the attribute type 2 with an arrow, the attributes of these columns are associated with each other. Therefore, a boundary between the column of “last name” and the column of “first name” is not a division position.

Next, the column of “first name” is selected as the processing target column, and the attribute type 2 of the column of “first name” is compared with the attribute type 3 of the column of “address 1”. In the digraph 1901, the attribute type 2 is not connected to the attribute type 3 with the arrow, and the attribute types 2 and 3 are not included in the digraph 1902. Therefore, the attributes of these columns are not associated with each other. Therefore, a boundary between the column of “first name” and the column of “address 1” is specified as a division position.

Next, the column of “address 1” is selected as the processing target column, and the attribute type 3 of the column of “address 1” is compared with the attribute type 3 of the column of “address 2”. Because the attribute types of the two columns are the same, the attributes of these columns are associated with each other. Therefore, a boundary between the column of “address 1” and the column of “address 2” is not a division position.

Next, the column of “address 2” is selected as the processing target column, and the attribute type 3 of the column of “address 2” is compared with the attribute type 3 of the column of “address 3”. Because the attribute types of the two columns are the same, the attributes of these columns are associated with each other. Therefore, a boundary between the column of “address 2” and the column of “address 3” is not a division position.

Next, the column of “address 3” is selected as the processing target column, and the attribute type 3 of the column of “address 3” is compared with the attribute type 5 of the column of “product name”. In either one of the digraph 1901 or the digraph 1902, the attribute types 3 and 5 are not connected with the arrow. Therefore, the attributes of these columns are not associated with each other. Therefore, a boundary between the column of “address 3” and the column of “product name” is specified as a division position.

Next, the column of “product name” is selected as the processing target column, and the attribute type 5 of the column of “product name” is compared with the attribute type 6 of the column of “manufacturer”. In the digraph 1902, because the attribute type 5 is connected to the attribute type 6 with an arrow, the attributes of these columns are associated with each other. Therefore, a boundary between the column of “product name” and the column of “manufacturer” is not a division position.

According to the data processing device 1401 in FIG. 14, by analyzing the analysis target table data 1422, the attribute set 1424 reflecting the attribute arrangement order that is easily understood by humans is generated. Then, the digraph 1425 indicating the combination of the two associated attributes is generated from the attribute set 1424. By using the generated digraph 1425, it is possible to accurately detect the division position of the information even from the processing target table data 422 of which the operation history is unknown.

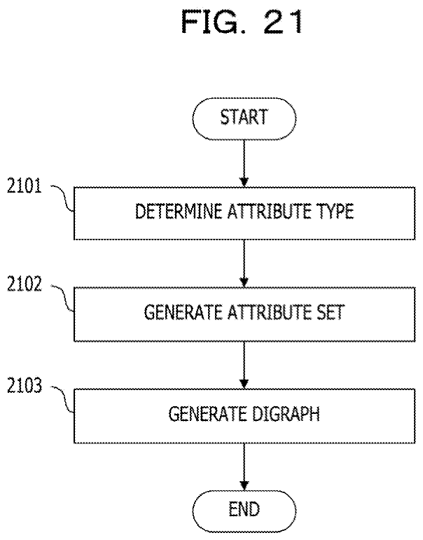

FIG. 21 is a flowchart illustrating an example of digraph generation processing executed by the data processing device 1401 in FIG. 14. First, the attribute determination unit 1412 determines an attribute type of each column of the one or more pieces of analysis target table data 1422 using the attribute value information 1421 (step 2101).

Next, the generation unit 1413 generates an attribute set 1424 including the attribute types of the plurality of attributes determined with respect to the one or more pieces of analysis target table data 1422 (step 2102). Then, the generation unit 1413 generates a digraph 1425 indicating a combination of two associated attributes among the attributes included in the attribute set 1424 (step 2103).

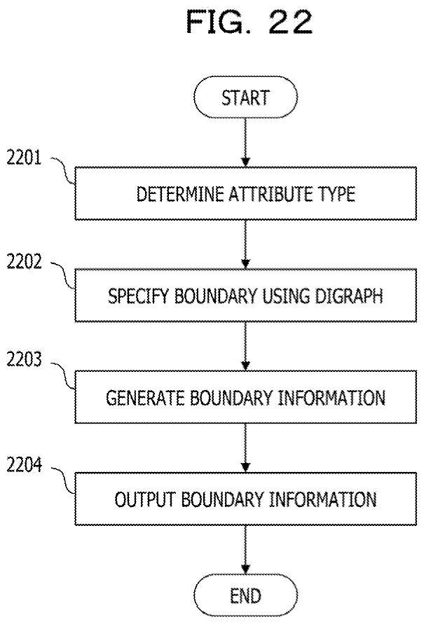

FIG. 22 is a flowchart illustrating an example of second division position detection processing executed by the data processing device 1401 in FIG. 14. First, the attribute determination unit 1412 determines an attribute type of each column of the processing target table data 1423 using the attribute value information 1421 (step 2201).

Next, the specification unit 1414 specifies a boundary corresponding to the division position of the information among boundaries between two attributes included in the processing target table data 1423, using the digraph 1425 (step 2202). Next, the specification unit 1414 generates the boundary information 1426 indicating the specified boundary (step 2203), and the output unit 1415 outputs the boundary information 1426 (step 2204).

In the determination processing for determining whether or not the two attribute types are connected with the arrow, it is possible to extend the predetermined range using a certain attribute type as a reference to three consecutive columns. In this case, a reference column to which the certain attribute type belongs, a first adjacent column adjacent to the reference column, and a second adjacent column adjacent to the first adjacent column are used as the three consecutive columns.

Two attribute types associated with the reference column exist in the predetermined range, and two attribute types respectively associated with the reference column and the first adjacent column also exist in the predetermined range. Moreover, two attribute types respectively associated with the reference column and the second adjacent column exist in the predetermined range.

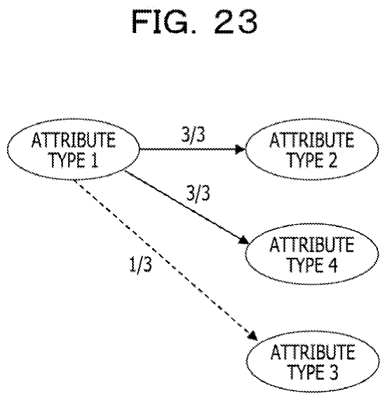

FIG. 23 illustrates an example of determination processing in a case where the predetermined range is expanded. In the determination processing in

FIG. 23, the attribute type 1 is set as a reference, In FIGS. 17A to 17E, other attribute types associated with the reference column same as the attribute type 1, the first adjacent column adjacent to the attribute type 1, or the second adjacent column adjacent to the first adjacent column are as follows.

Table data (a): attribute types 2, 4, and 3

Table data (b); attribute types 2 and 4

Table data (c): attribute types 2 and 4

Table data (d): none

Table data (e): none

The attribute type 1 appears three times in total, the attribute type 2 appears three times in the predetermined range using the attribute type 1 as a reference, the attribute type 4 appears three times, and the attribute type 3 appears once. Therefore, a frequency F (1, 2) at which the attribute type 2 exists in the predetermined range, a frequency F (1, 4) at which the attribute type 4 exists in the predetermined range, and a frequency F (1, 3) at which the attribute type 3 appears in the predetermined range are calculated using the following formulas.

F (1, 2)=3/3>0.5 (31)

F (1, 4)=3/3>0.5 (32)

F (1, 3)=1/3<0.5 (33)

In this case, because F (1, 2)>TF, F (1, 4)>TF, and F (1, 3)<TF are satisfied, an arrow from the attribute type 1 toward the attribute type 2 and an arrow from the attribute type 1 toward the attribute type 4 are generated, and an arrow from the attribute type 1 toward the attribute type 3 is not generated. The determination processing using the attribute types 2 to 8 as references is similarly executed, and the digraph 1425 is generated.

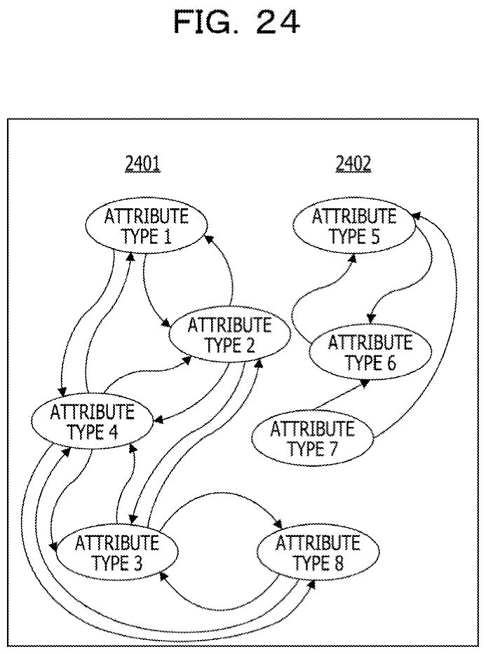

FIG. 24 illustrates an example of the digraph 1425 in a case where the predetermined range is expanded. A digraph 2401 in FIG. 24 includes the attribute types 1 to 4 and 8, and a digraph 2402 includes the attribute types 5 to 7. In each digraph, the two attribute types connected with any one arrow indicate a combination of two associated attributes.

In this case, as in FIGS. 10A to 10D, the specification unit 1414 sets a window having a size of three on the processing target table data 1423, and acquires attribute types of three columns included in the window while shifting the window. Then, the specification unit 1414 specifies an attribute type of a column included in the left region and an attribute type of a column included in the right region regarding each boundary included in the window.

Next, the specification unit 1414 compares the attribute type in the left region with the attribute type in the right region and checks whether or not the attribute in the left region is associated with the attribute in the right region. In a case where the two attribute types are the same attribute type, the specification unit 1414 determines that the attribute in the left region is associated with the attribute in the right region.

In a case where the two attribute types are different attribute types from each other, the specification unit 1414 checks whether or not the attribute types are connected with the arrow in the digraph 1425. In a case where the two attribute types are connected with the arrow, the specification unit 1414 determines that the attribute in the left region is associated with the attribute in the right region. On the other hand, in a case where the two attribute types are not connected with the arrow, the specification unit 1414 determines that the attribute in the left region is not associated with the attribute in the right region.

In a case where the two attributes are associated with each other, the specification unit 1414 determines that a boundary between the left region and the right region is not a division position, and in a case where the two attributes are not associated with each other, the specification unit 1414 determines that the boundary is the division position.

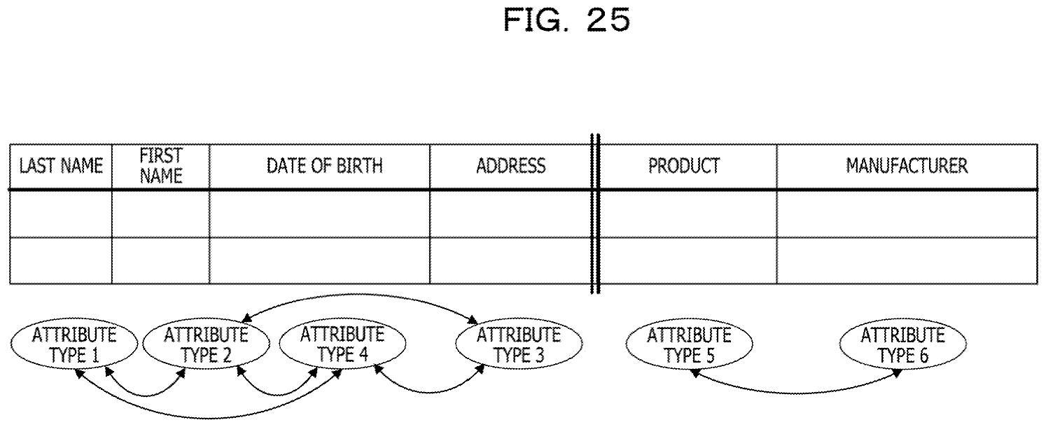

FIG. 25 illustrating an example of a division position in the processing target table data 1423 in a case where the predetermined range is expanded. An attribute type of a column of “last name” in the processing target table data 1423 in FIG. 25 is determined as the attribute type 1, and an attribute type of a column of “first name” is determined as the attribute type 2. An attribute type of a column of “date of birth” is determined as the attribute type 4, and an attribute type of a column of “address” is determined as the attribute type 3. An attribute type of a column of “product” is determined as the attribute type 5, and an attribute type of a column of “manufacturer” is determined as the attribute type 6.

In the digraph 2401 in FIG. 24, the attribute types 1 and 2 are connected with an arrow, the attribute types 2 and 4 are connected with an arrow, and the attribute types 4 and 3 are connected with an arrow. Furthermore, in the digraph 2402, the attribute types 5 and 6 are connected with an arrow.

On the other hand, the attribute types 4 and 5 are not connected with an arrow, and the attribute types 3 and 5 are not connected with an arrow, and the attribute types 3 and 6 are not connected with an arrow. Therefore, a boundary between the column of “address” and the column of “product” is specified as a division position.

The configurations of the data processing device 201 in FIG. 2, the data processing device 401 in FIG. 4, the data processing device 1301 in FIG. 13, and the data processing device 1401 in FIG. 14 are merely examples, and some components may be omitted or changed according to applications or conditions of the data processing device.

For example, in the data processing device 401 in FIG. 4 and the data processing device 1301 in FIG. 13, in a case where the attribute set 423 and the correlation rule 424 are generated by an external device, the generation unit 412 can be omitted. In a case where the attribute set 1424 and the digraph 1425 are generated by an external device, in the data processing device 1401 in FIG. 14, the generation unit 1413 can be omitted.

The flowcharts illustrated in FIGS. 3, 11, 12, 21, and 22 are merely examples and some processes may be omitted or changed depending on the configuration or conditions of the data processing device.

The method for estimating the division position illustrated in FIG. 1 is merely an example, and the division position may be estimated on the basis of an operation history of an operation other than the operation for combining two pieces of table data. The analysis target table data illustrated in FIGS. 5A to 5D and 16A to 16E is merely an example, and an attribute set may be generated using another analysis target table data.

The attribute sets illustrated in FIGS. 6 and 7A to 7C are merely examples, and the attribute set changes according to the analysis target table data. The basket data illustrated in FIG. 8 is merely an example, and the basket data changes according to the attribute set. The correlation rule illustrated in FIG. 9 is merely an example, and the correlation rule changes according to the attribute set. The processing target table data illustrated in FIGS. 10A to 10D, 20, and 25 is merely an example, and division position detection processing may be using another processing target table data.

The attribute value information illustrated in FIG. 15 is merely an example, and the attribute value information changes according to the analysis target table data. The attribute type illustrated in FIGS. 17A to 17E is merely an example, and the attribute type changes according to the analysis target table data and the attribute value information. The determination processing illustrated in FIGS. 18A to 18H and 23 is merely an example, and the digraph may be generated according to another determination processing. The digraphs illustrated in FIGS. 19 and 24 are merely examples, and the digraph changes according to the attribute set. The division position detection processing may be executed using an undirected graph instead of the digraph.

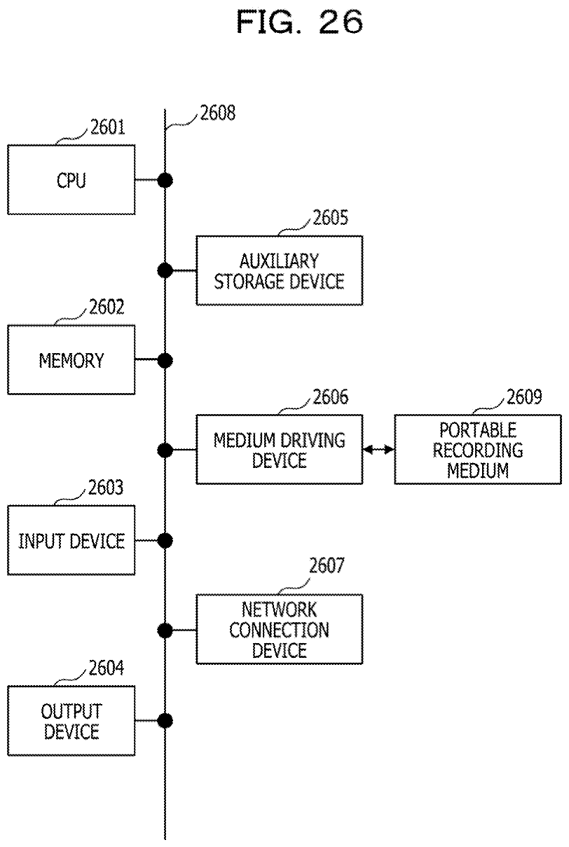

FIG. 26 illustrates a hardware configuration example of an information processing device (computer) used as the data processing device 201 in FIG. 2, the data processing device 401 in FIG. 4, the data processing device 1301 in FIG. 13, and the data processing device 1401 in FIG. 14. The information processing device in FIG. 26 includes a central processing unit (CPU) 2601, a memory 2602, an input device 2603, an output device 2604, an auxiliary storage device 2605, a medium driving device 2606, and a network connection device 2607. These components are hardware and are connected to each other by a bus 2608.

The memory 2602 includes, for example, a semiconductor memory such as a read only memory (ROM), a random access memory (RAM), or a flash memory and stores programs and data used for processing. The memory 2602 may operate as the storage unit 211 in FIG. 2, the storage unit 411 in FIGS. 4 and 13, or the storage unit 1411 in FIG. 14.

The CPU 2601 (processor), for example, executes a program using the memory 2602 so as to operate as the specification unit 212 in FIG. 2. The CPU 2601 executes the program using the memory 2602 so as to operate as the generation unit 412 and the specification unit 413 in FIGS. 4 and 13. The CPU 2601 executes the program using the memory 2602 so as to operate as the attribute unification unit 1311 in FIG. 13. The CPU 2601 executes the program using the memory 2602 so as to operate as the attribute determination unit 1412, the generation unit 1413, and the specification unit 1414 in FIG. 14.

The input device 2603 is, for example, a keyboard, a pointing device, or the like and is used for inputting an instruction or information from an operator or a user. The output device 2604 is, for example, a display device, a printer, or the like and is used for an inquiry or an instruction to the operator or the user, and outputting a processing result. The processing result may be the boundary information 425 or the boundary information 1426. The output device 2604 may operate as the output unit 213 in FIG. 2, the output unit 414 in FIGS. 4 and 13, or the output unit 1415 in FIG. 14.

The auxiliary storage device 2605 is, for example, a magnetic disk device, an optical disk device, a magneto-optical disk device, a tape device, or the like. The auxiliary storage device 2605 may be a hard disk drive or a flash memory. The information processing device can store programs and data in the auxiliary storage device 2605 and load these programs and data into the memory 2602 so as to use the programs and data. The auxiliary storage device 2605 may operate as the storage unit 211 in FIG. 2, the storage unit 411 in FIGS. 4 and 13, or the storage unit 1411 in FIG. 14.

The medium driving device 2606 drives a portable recording medium 2609 and accesses content recorded in the portable recording medium 2609. The portable recording medium 2609 is a memory device, a flexible disk, an optical disk, a magneto-optical disk, or the like. The portable recording medium 2609 may be a compact disk read only memory (CD-ROM), a digital versatile disk (DVD), a universal serial bus (USB) memory, or the like. The operator or the user can store programs and data in the portable recording medium 2609 and load these programs and data into the memory 2602 so as to use the programs and data.

As described above, a computer-readable recording medium in which the programs and data used for processing are stored includes a physical (non-transitory) recording medium such as the memory 2602, the auxiliary storage device 2605, and the portable recording medium 2609.

The network connection device 2607 is a communication interface circuit that is connected to a communication network such as a local area network (LAN) or a wide area network (WAN), and that performs data conversion pertaining to communication. The information processing device can receive programs and data from an external device via the network connection device 2607 and load these programs and data into the memory 2602 so as to use the programs and data. The network connection device 2607 may operate as the output unit 213 in FIG. 2, the output unit 414 in FIGS. 4 and 13, or the output unit 1415 in FIG. 14.

Note that the information processing device does not need to include all the components in FIG. 26, and some components can be omitted according to applications or conditions of the information processing device. For example, in a case where the portable recording medium 2609 or the communication network is not used, the medium driving device 2606 or the network connection device 2607 may be omitted.

While the disclosed embodiments and the advantages thereof have been described in detail, those skilled in the art will be able to make various modifications, additions, and omissions without departing from the scope of the embodiments as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a data processing program for causing a computer to execute processing comprising:
specifying one of boundaries between two adjacent attributes in processing target table data on the basis of association information that indicates a combination of two associated attributes among a plurality of attributes generated by analyzing analysis target table data that includes an attribute value of each of the plurality of attributes; and
outputting boundary information that indicates the one of boundaries.

2. The non-transitory computer-readable recording medium storing the data processing program according to claim 1, wherein the processing that specifies the one of boundaries includes processing that specifies a boundary other than the boundaries between the two attributes included in the combination of the two associated attributes as the one of boundaries.

3. The non-transitory computer-readable recording medium storing the data processing program according to claim 1, wherein the association information is generated by analyzing a plurality of pieces of analysis target table data including the analysis target table data and indicates the combination of the two associated attributes from among a plurality of attributes included in an attribute set generated from the plurality of pieces of analysis target table data.

4. The non-transitory computer-readable recording medium storing the data processing program according to claim 3, wherein the two associated attributes are two attributes with a frequency at which the two attributes exist in a predetermined range in the plurality of pieces of analysis target table data and which is higher than a threshold, among the plurality of attributes included in the attribute set.

5. The non-transitory computer-readable recording medium storing the data processing program according to claim 1, wherein the association information includes a correlation rule that indicates the combination of the two associated attributes.

6. The non-transitory computer-readable recording medium storing the data processing program according to claim 1, wherein the association information includes a graph that indicates the combination of the two associated attributes.

7. A data processing device comprising:
a memory; and
a processor coupled to the memory and configured to:
specify one of boundaries between two adjacent attributes in processing target table data on the basis of association information that indicates a combination of two associated attributes among a plurality of attributes generated by analyzing analysis target table data that includes an attribute value of each of the plurality of attributes; and
output boundary information that indicates the one of boundaries.

8. The data processing device according to claim 7 wherein the processing that specifies the one of boundaries includes processing that specifies a boundary other than the boundaries between the two attributes included in the combination of the two associated attributes as the one of boundaries.

9. The data processing device according to claim 7, wherein the association information is generated by analyzing a plurality of pieces of analysis target table data including the analysis target table data and indicates the combination of the two associated attributes from among a plurality of attributes included in an attribute set generated from the plurality of pieces of analysis target table data.

10. The data processing device according to claim 9, wherein the two associated attributes are two attributes with a frequency at which the two attributes exist in a predetermined range in the plurality of pieces of analysis target table data and which is higher than a threshold, among the plurality of attributes included in the attribute set.

11. The data processing device according to claim 7, wherein the association information includes a correlation rule that indicates the combination of the two associated attributes.

12. The data processing device according to claim 7, wherein the association information includes a graph that indicates the combination of the two associated attributes.

13. A data processing method comprising:
specifying, by a computer, one of boundaries between two adjacent attributes in processing target table data on the basis of association information that indicates a combination of two associated attributes among a plurality of attributes generated by analyzing analysis target table data that includes an attribute value of each of the plurality of attributes; and
outputting boundary information that indicates the one of boundaries.

14. The data processing method according to claim 13, wherein the processing that specifies the one of boundaries includes processing that specifies a boundary other than the boundaries between the two attributes included in the combination of the two associated attributes as the one of boundaries.

15. The data processing method according to claim 13, wherein the association information is generated by analyzing a plurality of pieces of analysis target table data including the analysis target table data and indicates the combination of the two associated attributes from among a plurality of attributes included in an attribute set generated from the plurality of pieces of analysis target table data.

16. The data processing method according to claim 15, wherein the two associated attributes are two attributes with a frequency at which the two attributes exist in a predetermined range in the plurality of pieces of analysis target table data and which is higher than a threshold, among the plurality of attributes included in the attribute set.

17. The data processing method according to claim 13, wherein the association information includes a correlation rule that indicates the combination of the two associated attributes.

18. The data processing method according to claim 13, wherein the association information includes a graph that indicates the combination of the two associated attributes.
